(19) United States
(12) Patent Application Publication
(10) Pub. No.: US 2002/0112024 A1
(43) Pub. Date: Aug. 15, 2002

(54) Scanner with direct data forwarding capacity

(76) Inventors: Chang-Hwa Yang, Taipei (TW); Chih-Shin Lan, Taipei Hsien (TW)

Correspondence Address: J.C. Patents, Inc., Suite 114, 1340 Reynolds Ave., Irvine, CA, 92614, US

(21) Appl. No.: 09/829,287

(22) Filed: Apr. 9, 2001

(30) Foreign Application Priority Data
Feb. 13, 2001 (TW) 90103095

(51) Int. Cl. G06F 15/16

(52) U.S. Cl. 709/217; 709/219

(57) ABSTRACT

A direct forwarding scanning system and method of operation. The direct forwarding system scans an object item on a scanner to produce image data and directly forwards the image data to a remote server computer via a user-end computer. The remote server computer executes an application program for processing incoming data. The user-end computer transmits image data to the remote server computer. The scanner is coupled to the user-end computer. The scanner includes a button for initiating the scanning of an object item and directly forwarding the scanned data to the remote server computer via the user-end computer.

### CROSS-REFERENCE TO RELATED APPLICATION

This application claims the priority benefit of Taiwan application serial no. 90103095, filed Feb. 13, 2001.

### BACKGROUND OF THE INVENTION

1. Field of Invention

The present invention relates to a direct scanning system. More particularly, the present invention relates to a scanning system having the capacity to forward scanned image data directly to a far end computer server.

2. Description of Related Art

In general, a image-scanning operation is carried out in a scanner directed by a scanning program inside a user-end computer with LED indicators on the scanner for indicating the scanning status. After extracting image data from a scanned document, the data is transmitted back to the user-end computer. The image data is then stored inside a storage device within the user-end computer. If the image data needs to be forwarded to a remote server computer, image data within the storage device of the user-end computer is retrieved and transmitted to the server using a forwarding application program.

However, this type of data forwarding technique has several drawbacks:

1. User has to spend time learning the application program.

2. A lot of time is wasted by the user-end computer in directing the scanning operation and forwarding the scanned image data to the remote terminal.

3. Image data tends to occupy a lot of storage space inside the user-end computer.

FIG. 1 is a block diagram showing the connections between a scanner, a user-end computer and a remote server in a conventional scanning system. FIG. 2 is a flow diagram showing the progression of steps for operating the scanning system in FIG. 1. As shown in FIG. 1, the scanning system includes a scanner 100, a user-end computer 102 and a remote server computer 112. The user-end computer 102 further includes an input/output interface 104, a storage device 108 and a forwarding application program 110. As shown in FIG. 2, to initiate a scanning operation, a button on the scanner 100 is pressed in step s200. A scanning operation is initiated by the scanner 100 to obtain image data. The image data is transmitted to the user-end computer 102 in step s202. After receiving the image data, the input/output interface 104 of the user-end computer 102 stores the image data inside the storage device 108. If the image data needs to forward to the remote server computer 112 in step s204, the image data is retrieved from the storage device 108. Thereafter, the image data is forwarded to the remote server computer 112 using the forwarding application program 110 inside the user-end computer 102. In brief, by providing a button on the scanner 100 so that scanned image data can be transmitted to the user-end computer 102 directly without depending on the forwarding application program to direct the scanner 100. Hence, users do not have to spend too much time learning how to use the application programs. However, the following drawbacks persist:

1. A lot of time is still required to process scanning and forward data; and

2. A large section of the storage space within the user-end computer has to be reserved for holding image data.

Another conventional technique is to enhance a scanner's function by introducing additional functional keys so that the scanner is capable of scanning as well as copying. However, the setting of additional functions in the scanner has no direct effect on the drawbacks.

### SUMMARY OF THE INVENTION

Accordingly, one object of the present invention is to provide a direct forwarding scanning system that uses up less user-end computer time for processing and scanning and requires less storage space inside the user-end computer.

The direct forwarding scanning system includes a scanner, a user-end computer and a remote server computer. The user-end computer further includes an input/output interface and driving program and the remote server computer further includes an application program. To scan a document and forward the scanned image data to the remote server computer, the document is placed on the scanner and then a button on the scanner is pressed to initiate the scanning. The image data is transmitted to the input/output interface of the user-end computer. The input/output interface retransmits the image data to the driving program of the user-end computer for further processing. The driving program transmits all relevant image data parameters to the remote server computer via an Internet. Thereafter, the parameters are processed using the application software inside the remote server. The application software may store up the image data in a file in a databank or the image is directly printed. Alternatively, the image data may be re-transmitted through a network in an electronic-mail format.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram showing the connections between a scanner, a user-end computer and a remote server in a conventional scanning system;

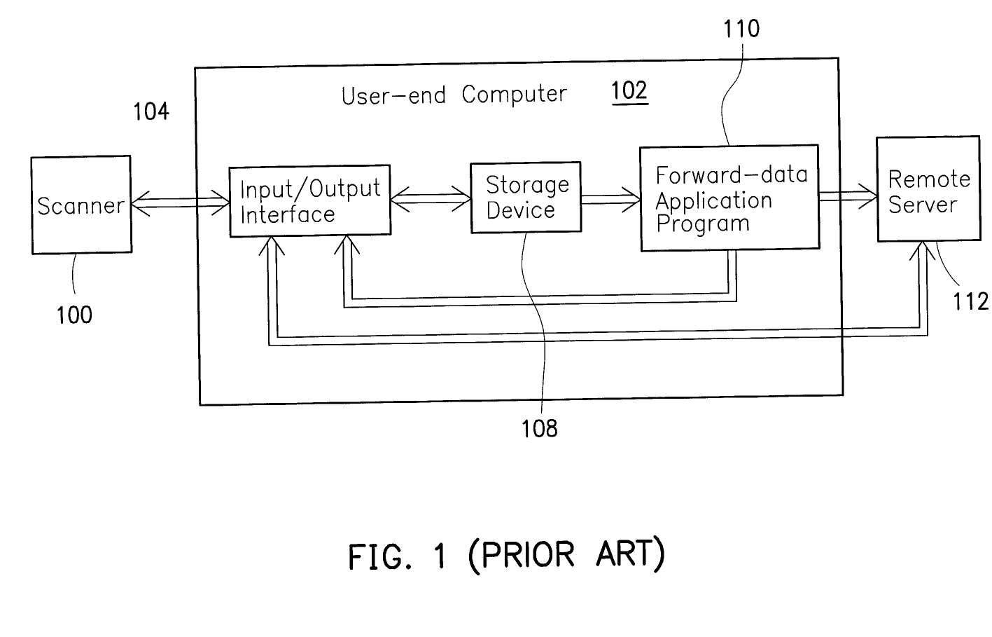

FIG. 2 is a flow diagram showing the progression of steps for operating the scanning system in FIG. 1;

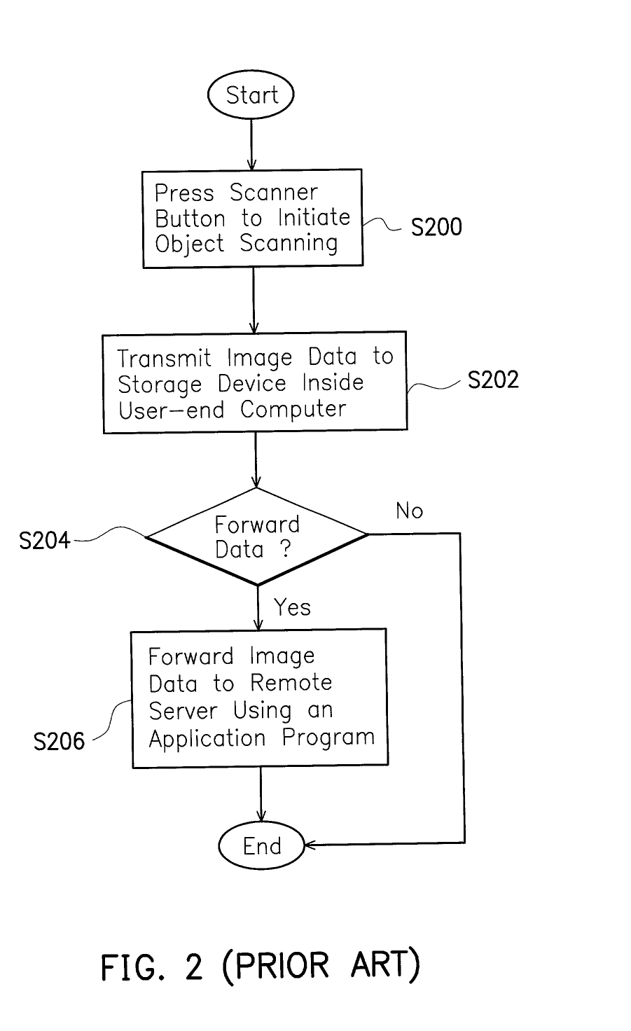

FIG. 3 is a schematic diagram showing the process of scanning an object item using a scanning system designed according to one preferred embodiment of this invention;

FIG. 4 is a block diagram showing the components of a scanning system according to one preferred embodiment of this invention; and

FIG. 5 is a flow chart showing the steps for operating the scanning system of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

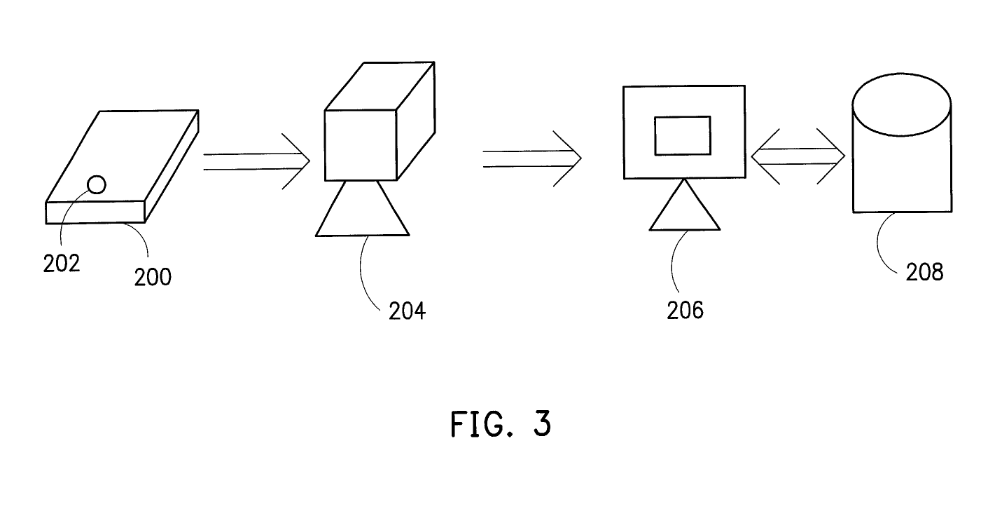

FIG. 3 is a schematic diagram showing the process of scanning an object item using a scanning system designed according to one preferred embodiment of this invention. As shown in FIG. 3, the scanning of an object item such as a document or a picture is carried out in a series of steps. The scanning system includes a scanner 200, a user-end computer 204, a remote server computer 206 and a databank 208. To begin scanning a document on the scanner 200, a button 202 on the scanner 200 is pressed to activate the scanner 200. The scanned image data is transferred from the scanner 200 to the user-end computer 204. Thereafter, the image data is forwarded directly to the remote server computer 206. The image data may be forwarded from the user-end computer 204 to the remote server 206 via the Internet. If image data is forwarded through the Internet, the user-end computer 104 is connected to the Internet through a modem or a local area network (LAN).

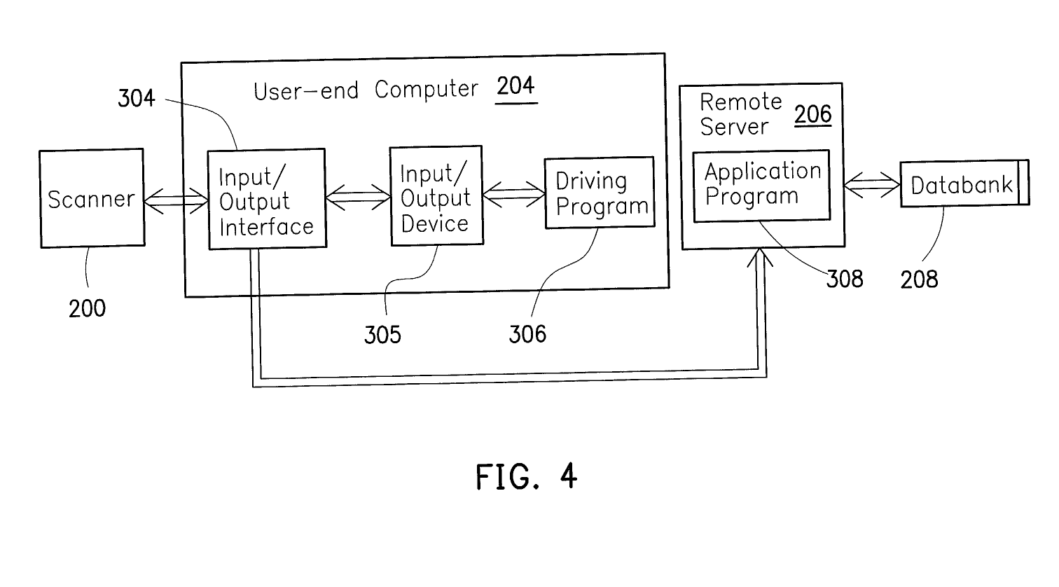

FIG. 4 is a block diagram showing the components of a scanning system according to one preferred embodiment of this invention. As shown in FIG. 4, the scanning system for direct forwarding of image data includes a scanner 200, a user-end computer 204, a remote server computer 206 and a databank 208. The user-end computer 204 further includes an input/output interface 304, a storage device 305 and a driving program 306. The remote server computer 206 includes an application program 308.

The input/output interface 304 inside the user-end computer 204 receives scanned data from the scanner 200. The driving program 306 inside the user-end computer 204 processes the incoming image data from the scanner 200 and forwards the data to the remote server computer 206. Operations conducted by the driving program 306 include assigning preset values such as resolution, color model and dimension to the image data and forwarding the preset values directly to the remote server computer 206. Through the application program 308 inside the remote server computer 206, image data from the user-end computer 204 is processed. For example, the image data may be gathered into a file and stored inside the databank 208 or printed out by a printer. Alternatively, the image data may be re-transmitted in an electronic-mail format.

The storage device 305 inside the user-end computer 204 serves as a storage buffer for holding image data arriving at the input/output interface 304 and processed data from the driving program 306. However, the storage device 305 is not a critical component in this invention and may be left out.

To forward the data of an object item to the remote server computer 206, the object item is placed in the scanner 200. The driving program 306 inside the user-end computer 204 then assigns preset values for the object item. When a button 202 on the scanner 200 is pressed, an image of the data object is extracted and the image data is transmitted to the input/output interface 304 of the user-end computer 204. The input/output interface 304 then re-directs the image data to the storage device 305. The data within the storage device is transmitted to the driving program 306 for further processing so that image parameters are produced. Thereafter, the driving program 306 forwards the image data and the image parameters to the remote server computer 306 via the Internet. The image data is processed by the application program 308 inside the remote server computer 206. The image data is gathered into a file and stored inside the databank 208 or printed out directly. Alternatively, the image data is re-transmitted out in the form of an electronic mail.

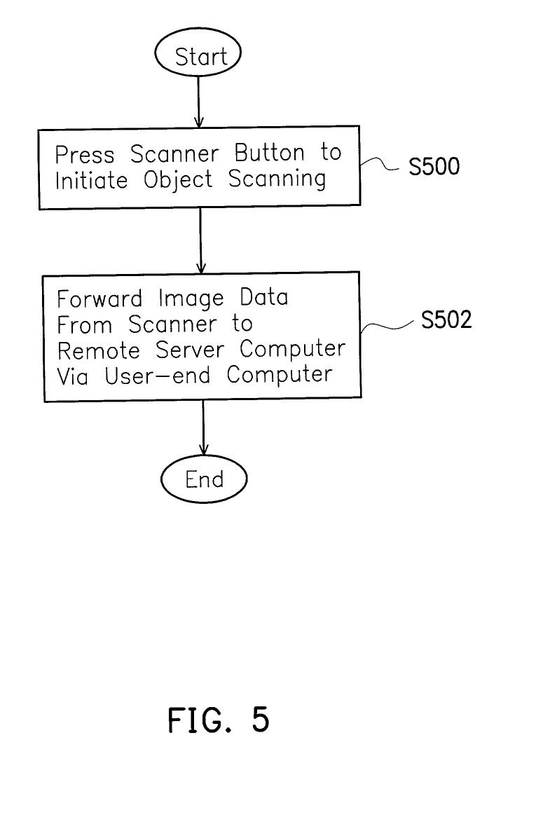

FIG. 5 is a flow chart showing the steps for operating the scanning system of this invention. As shown in FIG. 5, the direct forwarding of scanned data from a scanner to a remote server computer involves two major steps. In step S500, a button on the scanner is pressed. In step S502, image data of an object item placed on the scanner is extracted and the image data is directly forwarded to the remote server computer via a user-end computer.

In summary, major advantages of this invention includes:

1. Very little time is spent by the user-end computer to process the scan data and forward the scan data. The scan data is directly transmitted to a remote server computer through a driving program.

2. Image data does not occupy space inside the storage device of the user-end computer because image data is immediately forwarded to the remote server computer on arriving at the user-end computer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for directly forwarding image data captured by a scanner, comprising:
a remote server computer having an application program for processing received image data;
a user-end computer for transmitting image data to the remote server computer; and
a scanner having a scan button thereon and coupled to the user-end computer, wherein the scanner scans an object item and extracts image data from the object item when the scan button is pressed, and the image data is directly forwarded to the remote server computer via the user-end computer.

2. The system of claim 1, wherein the object item includes a document or a photograph.

3. The system of claim 1, wherein the user-end computer includes:
a driving program for processing the scanned object item and directly forwarding image data of the scanned object item to the remote server computer;
an input/output interface connected to the scanner for receiving image data from the scanner and forwarding the driving program processed image data to the remote server computer; and
a storage device for holding the image data from the input/output interface and the processing data from the driving program.

4. The system of claim 3, wherein the driving program processes a desired object item by setting a series of preset values.

5. The system of claim 4, wherein the series of preset values set by the driving program includes a resolution preset value, a color model preset value and a dimension preset value.

6. The system of claim 3, wherein the direct forwarding of image data to the remote server computer by the driving program includes transmitting parameters related to the image data to the remote server computer.

7. The system of claim 6, wherein the parameters related to the image data transmitted by the driving program includes a resolution parameter, a color model parameter and a dimension parameter.

8. The system of claim 1, wherein the user-end computer forwards image data to the remote server computer via an Internet.

9. The system of claim 8, wherein the image data is transmitted to the Internet via a modem or a local area network.

10. The system of claim 1, wherein the application program processes incoming image data transmitted from the user-end computer by filing the image data or printing out the image data.

11. A scanner capable of directly forwarding data of a scanned object item from the scanner to a remote server computer, wherein the scanner has a button for initiating a scanning of the object item and then forwarding the scanned data directly to the remote server computer.

12. A method of directly forwarding scanned image data from a scanner, comprising:
pressing a button on the scanner; and
scanning an object item on the scanner to obtain image data and forwarding the image data to a remote server computer via a user-end computer.
